(19) United States
(12) Patent Application Publication
(10) Pub. No.: US 2006/0277444 A1
(43) Pub. Date: Dec. 7, 2006

(54) Recordation of error information

(76) Inventors: Nicholas Holian, Fort Collins, CO (US); Paul H. Vu, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/145,483

(22) Filed: Jun. 3, 2005

(51) Int. Cl. G06F 11/00

(52) U.S. Cl. 714/41

(57) ABSTRACT

Systems and methods are disclosed for recordation of error information. In one embodiment, a system may comprise a data bus and a data bus register that is associated with the data bus and with at least one device. An error record component causes error information to be recorded in the data bus register in response to detecting an error in data that is being transferred through a data path located between the data bus and the at least one device, the error information being sufficient to determine a quantity and a location of the error in the data that is being transferred through the data path.

### BACKGROUND

It is often desirable to be able to diagnose the source of errors that occur in computer systems, including at both the manufacturing stage as well as the after-market stage. Devices that can communicate via a computer resident data bus, such as controllers and interfaces, are typically manufactured with error detection, and in some cases, error correction capabilities. Upon errors being detected and corrected by these devices, the devices are capable of signifying that a single-bit or a multi-bit error occurred. It is usually only through extensive testing and using external hardware, such as a logic analyzer, that the source of an error in a device can be found.

### BRIEF DESCRIPTION OF THE DRAWINGS

FIG. 1 depicts an example of a system for recording error information in a data bus register.

FIG. 2 depicts an example of a computer system for recording error information in a data bus register.

FIG. 3 depicts another example of a computer system for recording error information in a data bus register.

FIG. 4 depicts an example of a data bus register of a computer system for recording error information.

FIG. 5 is a flow diagram depicting an example of a method for recording error information in a data bus register.

FIG. 6 is a flow diagram depicting an example of a method for recording error information in a data bus register and for accessing and retrieving the recorded error information.

### DETAILED DESCRIPTION

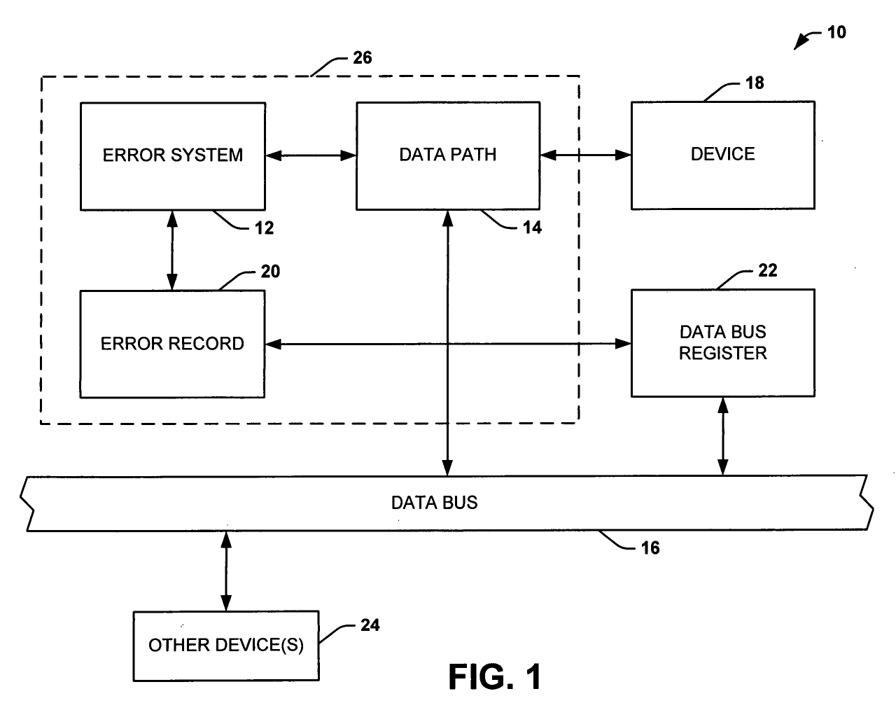

FIG. 1 depicts an example of a system 10. The system 10 includes an error system 12. The error system 12 monitors data that is transferred through a data path 14 that is interconnected between a data bus 16 and a device 18. The data can be transferred through the data path 14 in response to a request for the data, such as a read request or a write request, which can be initiated by other components or devices 24 in the system 10. The error system 12 is operative to detect errors associated with the data being transferred. The errors can include single-bit errors in a block of data being transferred (e.g., corresponding to a cache line) as well as multi-bit errors in the block of data.

It is to be understood that the error system 12, in the example of FIG. 1, could include additional functionality, such as error correction circuitry (ECC) operative to correct detected errors in a data block so that corrected data is returned to requesting circuitry. Such ECC, for example, may be configured to correct single-bit errors, multi-bit errors or both single-bit and multi-bit errors.

The system 10 also includes an error record component 20. The error record component 20 causes error information associated with the errors to be recorded in a data bus register 22 in response to the error system 12 detecting an error in the data transferred through the data path 14. The error record component 20 corresponds to hardware having at least write access to the data bus register 22. While the error record component 20 is depicted as being separate from the error system 12, the error record component could be implemented as part of the error system or other hardware (e.g., another component in the device interface 26) that has access to the data bus register. The error record component 20 may be part of the device interface 26 configured to access the data bus register for facilitating communications via the data bus 16 or, alternatively, the error record component 20 can be implemented specifically for recording error information. The system 10 could also include an enable component (not shown) that operates to enable/disable the ability of the error record component 20 to record the error information in the data bus register 22.

The error information recorded in the data bus register 22 can include be any information that is sufficient to determine a location and quantity of detected error(s) (e.g., in the corrupted data block). For example, the error information can include the corrupted data block, the corrected data block, or it can include both corrupted and corrected versions of the data block. The data bus register 22 thus can be configured with one or more blocks of contiguous data space sufficient to store the error information indicated by the error record component 20. The data bus register 22 further can be implemented as a register associated with the data bus 16.

The device 18 transfers data to and from the data bus 16 via the data path 14. The device 18 could be a device that is configured to communicate data via the data bus 16, for example, including a memory device (e.g., random access memory (RAM), a disk drive, read only memory, programmable read only memory (PROM), etc.), small computer system interface (SCSI) port, a bus interface, or any other type of input/output (I/O) peripheral device. The data bus 16 could be, for example, a peripheral component interconnect (PCI) bus operative to interconnect a number of devices for communication across the PCI bus. Other bus architectures could also be utilized. For the example of the data bus 16 being a PCI bus, the data bus register 22 can correspond to a PCI register space (e.g., configuration space) in which a portion of the address space is reserved for storing the recorded error information.

The error system 12, the data path 14, and the error record component 20 could all be included in a device interface, indicated at 26. The interface 26 could be one or more different integrated circuit (IC) chips that form a chipset. The interface 26 may further be incorporated into or otherwise form part of the device 18. Alternatively, the device interface 26 could be separate from the device 18, although connected with the interface as depicted in FIG. 1 (e.g., connected via another bus structure or interface).

It is to be understood that the system 10 could also include one or more other device(s) 24. The other device(s) 24 could include a separate data bus interface, such that data could be transferred between the device 18 and the other device(s) 24 through the data bus 16. As one example, the other device(s) 24 could include a diagnostic tool that can inject simulated errors into valid data blocks transferred through the data path 14. Still further, the other device(s) 24 may be configured to read error information from the data bus register 22 via the data bus 16. In addition to being used for storing error information associated with the device 18, the data bus register 22 could also be implemented as a shared structure that is utilized by the other device(s) 24 for communicating over the data bus 16. Alternatively, the data bus register 22 could be specific to the device 18, such as may be integrated into the device interface 26.

As mentioned above, the errors detected by the error system 12 could be single-bit errors, such that a data block includes a single corrupted bit, or multi-bit errors, such that a data block includes multiple corrupted bits. It is to be understood that the errors detected by the error system 12 could occur as a result of a device malfunction during operation of a computer that includes the system 10. Alternatively or additionally, the errors could be simulated errors that occur as a result of error injection, such as resulting from a software routine designed to test the operation of the error system 12 as well as other parts of the system 10. For example, the error injection can be implemented via the other device(s) 24 or other component in the system 10 that has access to the data path 14.

The data bus register 22 is also connected to the data bus 16. The error information that has been recorded in the data bus register 22 can be accessed via the data bus 16 for the purpose of diagnosing the system 10. For example, the error information recorded in the data bus register 22 by the error record component 20 can be accessed by a device that is connected to the data bus to determine the source of the error. Additionally or alternatively, upon a simulated error being injected into valid data that is subsequently transferred across the data path 14, the error information recorded in the data bus register 22 by the error record component 20 can be accessed by a device that is connected to the data bus to determine if the simulated errors were detected correctly. The error information can also be evaluated to determine if the system 10 responded to the simulated errors correctly, such as by properly correcting the injected errors in the above example, such as when the error system 12 includes ECC.

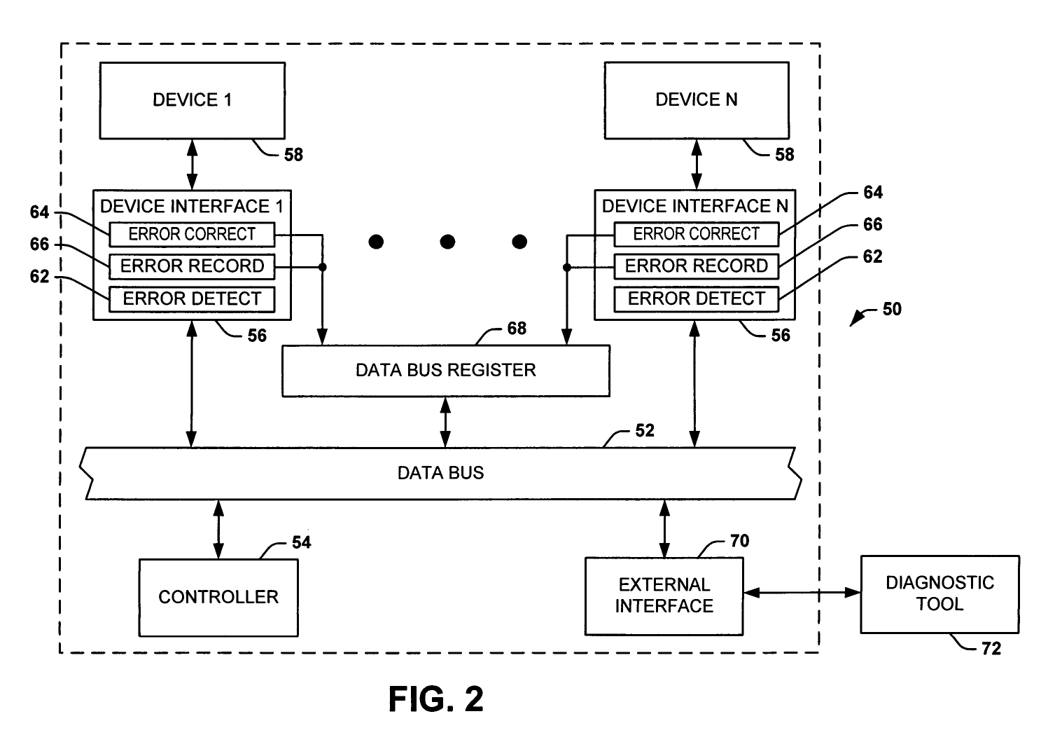

FIG. 2 depicts an example of a computer system 50 that is operative to record information associated with an error in data. The computer system 50 includes a data bus 52 and an associated controller 54. The controller 54 could be operative to facilitate communications between a number N of device interfaces 56, where N is positive integer (N≧1). Each device interface 56 is associated with a separate device 58, such that the N device interfaces 56 can communicate with each other by transmitting and receiving data between the respective devices 58 across the data bus 52. The controller 54 is configured to manage communications over the data bus 52. Thus, the controller 54 may be considered part of the data bus, such as including an arrangement of input queues and output queues as well as other hardware designed to manage and exchange data between interfaces 56.

By way of example, the data bus 52 can be a PCI bus operative to interconnect a number of peripheral devices for communication across the PCI bus. The device interfaces 56 thus may include memory controllers, SCSI controllers, bus interfaces, or other I/O peripheral device controllers connected with the data bus 52. In the example of a given interface 56 being implemented as a memory controller, the associated device 58 can correspond to a memory system, such as an arrangement of solid state memory implemented in the computer system 50. For instance, solid state memory can include random access memory (e.g., static RAM (SRAM), dynamic RAM (DRAM)), programmable ROM (e.g., flash memory), as well as any hierarchy of memory that may be associated with the memory system, which may or may not include a level of cache memory.

Each of the device interfaces 56 can also include an error detect component 62. The error detect component 62 detects errors that may occur in a data block that is transferred between the data bus 52 and the device 58. For example, one or more blocks of data (e.g. cache lines) can be transferred from the device 58 in response to a request (e.g., a read or write request) initiated by another device or component of the computer system 50 for such data.

One or more of the device interfaces 56 can also include an error correct component 64. The error correct component 64 can be implemented as ECC that is operative to correct detected errors in a corrupted data block to produce a corresponding corrected data block. The error correct component 64 can be configured to correct single-bit errors, multi-bit errors, or both single-bit and multi-bit errors. The error detect component 62 and the error correct component 64 could be implemented as a single error system.

Each of the device interfaces 56 also includes an error record component 66. The error record component 66 causes error information associated with the errors to be recorded in response to the error detect component 62 detecting an error in the data transferred between the data bus 52 and the device 58. Although the example computer system 50 illustrates that the N device interfaces 56 each includes an error detect component 62, an error record component 66, and an error correct component 64, not all of the N device interfaces 56 are required to include all three of these components. For example, different device interfaces can comprise different hardware, and some may further be unable to cause error information to be recorded. As an example, one or more of the device interfaces 56 could be integrated in a single IC, could be distributed in separate ICs within a chipset that forms the device interface 56, or could be hardware that is separate from the device interface 56 altogether.

The error detect component 62 operates to detect an error in the form of one or more corrupted bits in data block that are transferred through (e.g., read from or written to the respective device 58) via the device interface 56. In response to the error detect component 62 detecting an error in a corrupted data block, the error record component 66 causes error information to be recorded into a data bus register 68. The error information can be information that is sufficient to determine the location and the quantity of the corrupted bits in the corrupted data block. For example, the error record component 66 could cause the corrupted data block itself to be recorded into the data bus register 68. Since the error correct component 64 can correct the corrupted data block to produce a corrected data block, the error information could also include the corrected data block.

In the example computer system 50 of FIG. 2, the data bus register 68 can be accessible by the device interfaces 56. As one example, the device interfaces 56 can record respective error information directly into the data bus register 68. Additionally or alternatively, the device interfaces 56 could record the respective error information into the data bus register 68 via the data bus 52. That is, the device interfaces 56 are capable of accessing the error information recorded in the data bus register 68 directly or through the data bus 52.

The location within the data bus register 68 where the error information is recorded can be predetermined. For example, a range of addresses in the data bus register 68 can store the error information chronologically according to an order in which the errors occur. As another example, a range of addresses in the data bus register 68 can be assigned to each of the device interfaces 56, such that each device interface records error information in an predefine range of addresses of the data bus register. The addresses further can be overwritten or otherwise appended as additional error information is recorded in the data bus register 68. While a single data bus register 68 is depicted in the example of FIG. 2, it is to be understood and appreciated that the data bus register could be implemented as a plurality of separate registers that collectively define the register space represented by the register 68. Such separate registers may further be specific to each of the respective device interfaces 56.

The computer system 50 may also include an external interface 70 that allows a user access to the data bus register 68 from outside of the computer system 50 using a diagnostic tool 72. For example, the external interface 70 could include a serial port, a parallel port, or other port structure or bus interconnect of the computer system 50. The external interface thus enables a user to connect the diagnostic tool 72 to the external interface 70 for components in the system via the data bus 52. For instance, the diagnostic tool 72 can be configured to obtain error information recorded in the data bus register 68, such as by specifying corresponding address locations in the register.

By recording the error information into the data bus register 68, the error information can be accessed from the data bus register 68 to determine information about the computer system 50. As one example, the error information can be analyzed to ascertain the source of the error. For example, a device interface 56, such as DEVICE INTERFACE 1, could detect an error and record the error information in an appropriate address location in the data bus register 68. The external interface 70 can access the error information from the appropriate location of the data bus register 68 and analyze the error information to determine the quantity and location of one or more corrupted bits within the corrupted data block. As an example, if DEVICE INTERFACE 1 records the corrupted data block into the data bus register 68, a source of the error detected by the error detect component 62 of DEVICE INTERFACE 1 could thus be determined. This determination could be accomplished by accessing the corrupted data block from the appropriate location of the data bus register 68 and comparing the corrupted data block with the data block that was expected to be read from or written to the device interface 56 (e.g., an expected data block). As another example, if DEVICE INTERFACE 1 records the corrected data block as part of the error information, the corrected data block may also be evaluated to determine whether the error in the data block was corrected properly. This determination can be implemented, for example, by comparing the corrected data block with the corrupted data block or by comparing the corrected data block with the expected data block. Alternatively or additionally, the diagnostic tool may employ the error information (e.g., the corrupted data block and/or the corrected data block) to determine a source of the error detected by DEVICE INTERFACE 1.

External access to the data bus register 68 through the external interface 70 to the data bus 52 can also be utilized to diagnose the source of an error. For example, an uncorrectable error may disable an operating system of the computer system 50, resulting in the computer system “crashing.” Because the external interface 70 provides access to the data bus register 68 via the data bus even after the computer system 50 has crashed (assuming power is still supplied to the data bus), the error information obtained from the data bus register 68 can be employed to diagnose the source of the error. Additionally, because the data bus register 68 contains error information, which can include the corrupted data block and/or the corrected data block, external access to the data bus register 68 provides an efficient and economic alternative to many existing diagnostic methods.

By way of comparative example, many conventional diagnostic approaches involve opening a computer casing, thus possibly creating an unshielded and atypical computer system operating environment. Such conventional approaches further usually require the use of expensive test equipment, such as a logic analyzer, to monitor operating conditions. Such an unshielded environment could make diagnostic testing even more difficult by exposing the computer system to undesired electromagnetic interference (EMI). The exposure to EMI and other environmental conditions associated with such a test environment does not closely match the normal operating environment that exists when error information is recorded in the data bus register, as described herein. Accessing the error information from the data bus register 68 by connecting the diagnostic tool 72 into the external interface 70 thus could allow retrieving the error information during a normal computer operating environment, even during and after the time that the computer system 50 has crashed.

The diagnostic tool 72, or any of the device interfaces 56, can also be programmed and/or configured to include error injection capabilities for testing one or more device interfaces 56 as well as other components of the computer system 50. The error injection can be utilized to simulate the occurrence of an error (e.g., a single-bit or a multi-bit error) in a data block that is being transferred through the device interface relative to a respective device 58. Thus, errors can be injected to test the error detect component 62, the error correct component 64 or other components of a given device interface 56.

As one example, the diagnostic tool 72 can inject a single-bit or a multi-bit simulated error into a valid data block that is to be read from or written to a device 58. By employing a logic analyzer, a user can determine if the error detect component 62 of the device interface 56 corresponding to the device 58 has detected the injected simulated error and if the corrected data block corresponds to the valid data block. Such a process, however, can be facilitated more simply and accurately if both the corrupted data block and the corrected data block are recorded to the data bus register 68. For example, a user can access the error information, which could include both the corrupted data block and the corrected data block, from the data bus register 68 to determine if the error detection and error correction performed correctly. The user can thus analyze the error information recorded in the data bus register 68 relative to the injected simulated errors to determine if the location and quantity of corrupted bits correspond to the injected simulated errors (e.g., by performing a bit-wise comparison). The error information can also be employed to determine if the ECC is operating correctly by comparing and analyzing the corrected data block with the valid, expected data block. As described herein, this error injection and testing capability can be performed by accessing the data bus register 68 through an external connection to the external interface 70, thus negating the need for a logic analyzer or other generally expensive equipment.

The computer system 50 can include an enable feature that operates to selectively enable/disable recording the error information to the data bus register 68. The enable feature could be as simple as asserting a bit in an associated register. For example, when an enable bit is asserted, the error record component 66 of one or more of the device interfaces 56 can cause the error information to be recorded in response to the error detect component 62 detecting an error. The enable bit could be asserted by an input from a user, or could be asserted at preprogrammed times, as determined by the operating system or other software routine running in a processor of the computer system 50. Recordation of the error information can be disabled during normal operation of the computer system 50. It is to be understood that the enable feature could be specific to all of the device interfaces 56, or each of the device interfaces 56 individually. For example, each of the device interfaces 56 can have a separate enable bit for enabling the recordation of the error information specific only to that device interface 56. The enable bit for each of the device interfaces 56, for example, could be located in the data bus register 68, or it could be local to each device interface 56, such as part of the error record component 66.

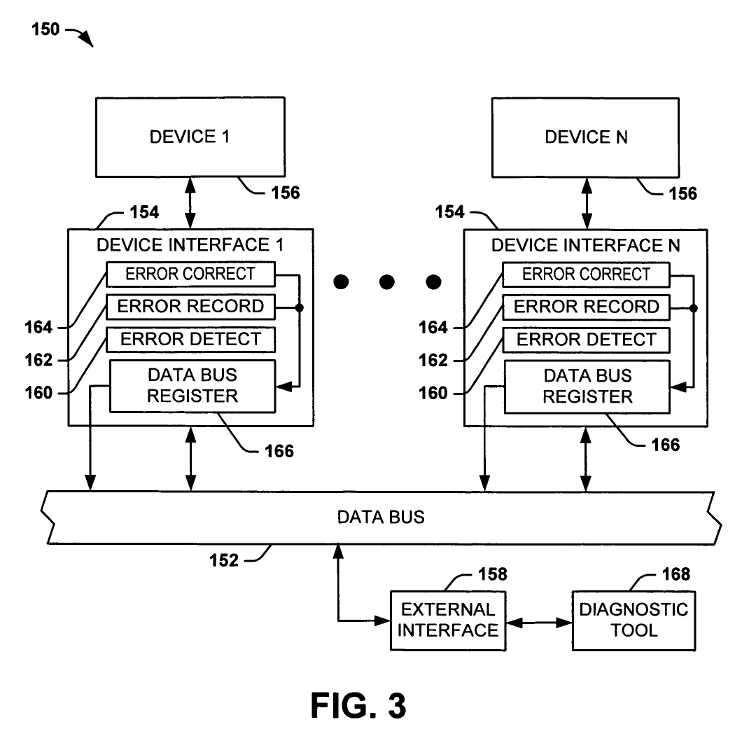

FIG. 3 demonstrates another example of a computer system 150 that is operative to record information associated with an error that occurs in data within a device that is connected to a data bus. In the example of FIG. 3, other computer system components have been omitted from FIG. 3 and the following discussion regarding FIG. 3. It is to be understood, however, that this omission is for the sake of brevity, and that various omitted computer system components may still operate in conjunction with the computer system 150.

The computer system 150 includes a data bus 152 that interconnects one or more device interfaces 154. Each of the device interfaces 154 operates to connect one or more devices 156 to enable transfer of data via the data bus 152. The data bus 152, for example, can be a PCI bus operative to interconnect the devices 156 for communication across the PCI bus. While the devices 156 are depicted as being external to the device interfaces 156, it is to be understood that the devices could be part of the device interface, such as part of an IC that forms the device interface or a chipset that includes a plurality of ICs. Each device can store information that can be accessed via the respective device interface, such as in response to a request provided over the data bus 152.

Each of the device interfaces 154 can be implemented as memory controllers, SCSI controllers, bus interfaces, or other I/O peripheral device controllers to name a few. Each of the device interfaces 154, as illustrated in FIG. 3, can include one or more of an error detect component 160, an error record component 162, and an error correct component 164. It is to be understood that the error detect component 160, the error record component 162, and the error correct component 164 can be configured and arranged to operate substantially similarly to the operation described above with regard to such components in FIG. 2.

In the example of FIG. 3, each of the device interfaces 154 also includes an associated data bus register 166. The data bus register 166 of each device interface 154 is a data bus register specifically for the device interface 154 itself The error record component 162 can cause error information to be recorded in the data bus register in response to the error detect component detecting an error in a data block that is being read from (or written to) the device 156. For example, each of the device interfaces 154 records error information into a range of memory addresses (e.g., a range of contiguous or non-contiguous memory) in its own respective data bus register 166. The data bus register 166 can be accessed by other devices via data bus 152, such as by accessing data in a predefined address range to which the error information has been stored in the data bus register.

The data bus register 166 for each device interface 154 could be part of an existing register space for the device interface 154. In other words, the data bus register 166 of each device interface 154 need not be limited to storing the error information. Instead, the data bus register 166 could include a range of predefined addresses for storing the error information, with one or more other address ranges utilized for other purposes associated with the operation of the device interface 154.

The data bus register 166 could include header and configuration register space for information specific to a given device 156. The header and configuration information enables the device 156 to properly interface with the data bus 152. That is, the header and configuration information can operate as an address that provides access to a range of addresses in the data bus register 166 for each given device 156. The address locations within the data bus register 166 to which the error information is recorded can be allocated by the manufacturer of the device 156. Additionally, the data bus register 166 of each device interface 154 could include an enable bit to selectively enable/disable the error record component 162 for recording error information in the data bus register 166. The error bit could also have a memory address within the data bus register 166 that is allocated by the manufacturer of the device 156, such that it can be modified via an instruction received via the data bus 152 that is addressed to such memory address location.

By way of example, if the data bus 152 is implemented as a PCI bus structure, each of the data bus registers 166 could be implemented as a corresponding configuration space (or PCI space) register for a respective device interface 154. For example, the configuration space for each of the devices 156 typically includes 256 bytes that are addressable, although it is possible that other bus standards might employ different size for configuration space (e.g., it can be extended to 4096 bytes, such as for PCI-X 2.0 and PCI Express). The configuration space for a given device thus can be accessed via the PCI data bus 152, such as by knowing the PCI bus identifier for the device and a function number associated with the device. The first 64 bytes of configuration space are typically standardised, including predetermined header information (e.g., often including Vendor ID and Device ID) that identify the respective devices 156. Additional housekeeping information, such as including a command register, a status register and cache line size register. The remainder of the configuration space is available for predefined purposes, such as may be specified by manufacturers of the respective devices 156. It is this latter portion of the configuration space that can be designed for use in storing the error information, as described herein.

The computer system 150 could also include an external interface 158 connected to the data bus 152. The external interface 158 could allow a user to access the data bus register 166 of any of the device interfaces 154 from outside of the computer system 150 using a diagnostic tool 168. The external interface 158 can be substantially similar to the device interfaces 154; although it may or may not include one or more of the error detect, error correct, and error record components. The external interface 158 can be implemented as a serial port or a parallel port on the computer system 150, such that a user could connect the diagnostic tool 168 or other external devices to access error information that has been recorded in the data bus register 166 of one or more of the device interfaces 156. For example, error information can be accessed via the data bus 152 by identifying the device specific address along with the predefined address location(s) where the error information is stored.

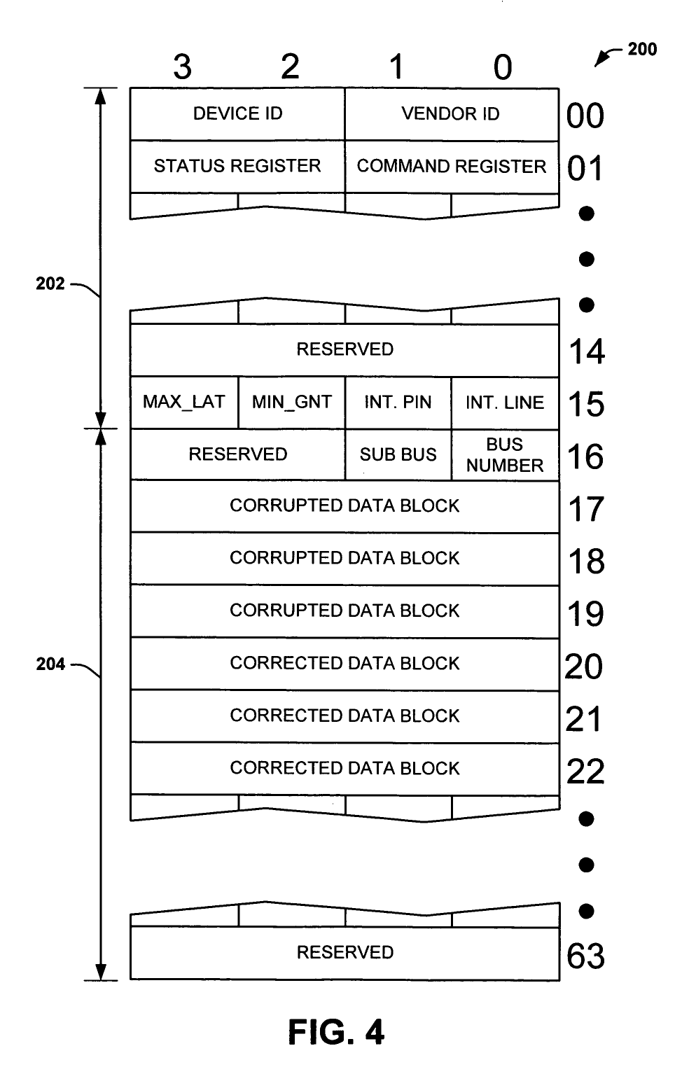

FIG. 4 demonstrates an example architecture of a PCI bus register 200, such as could be used in the example of FIG. 3. The example PCI bus register 200 includes 256 bytes, although it is possible that different sizes can be utilized (e.g., it can be extended to 4096 bytes, such as for PCI-X 2.0 and PCI Express). The PCI bus register 200 could be associated with a device that is connected to a PCI bus. The PCI register 200 could include 64 four-byte words (i.e., double words) of data, numbered 00-63.

The PCI bus register 200 includes a header region 202 that includes the first 16 double words of data corresponding to 64 bytes. The header region 202 identifies information about the device to which the PCI bus register 200 corresponds. For example, the header region could include, among other things, a vendor ID, a device code, and/or hardware compatibility codes. The header region, for instance, can also include a command register, a status address register, and a cache line size register. The command register contains a bitmask of features that can be individually enabled and disabled. The status register can be used to report which features are supported. The cache line size register, which should be programmed before a device can access associated memory, defines the size of memory blocks that are communicated in the computer system.

The PCI bus register 200 also includes a device specific region 204 that includes the remaining 48 double words of data. The device specific region 204 defines a register space that can be written to by a PCI controller or by one or more other devices that are capable of accessing the register space, such as a record component. The device specific region thus allows the corresponding device to communicate on the PCI bus. The device specific region 204 of the PCI bus register 200 can also be configured to record error information. As described herein, the error information can include corrupted data blocks, such as in the form of one or more contiguous blocks of register space (e.g., typically at least one cache line). The corrupted data blocks in the example are stored in register space corresponding to lines 17-19. The error information can also be used to store corrected data blocks associated with a detected error (e.g., as might be recorded to the data bus register 166 by the error record component 162 in the example of FIG. 3). The corrupted data blocks in the example are stored in register space corresponding to lines 20-22. It is to be understood that the register space for storing error information can vary from system to system, such as depending on the cache line size, which usually matches the cache line size of the processor(s) of the computer system.

The location and size of the register space available for the corrupted and the corrected data blocks can be determined by the manufacturer of the device with which the PCI bus register 200 is associated, and thus need not be limited by the example of FIG. 4. Additionally, the manufacturer of the device can designate a location in the device specific region 204 (or in the header region 202) for at least one enable bit, such that the recordation of corrupted data and corrected data into the device specific region 204 can be selectively enabled and disabled according to the value of such one or more bits.

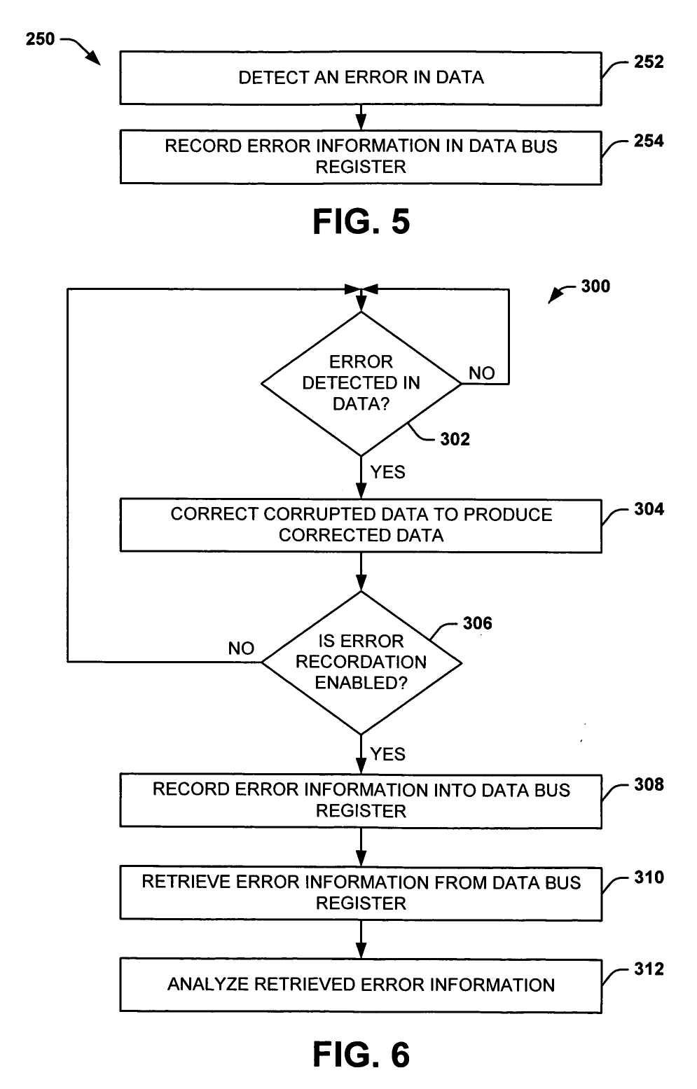

In view of the foregoing structural and functional features described above, certain methods will be better appreciated with reference to FIGS. 5-6. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., a computer or a computer network), software (e.g., as executable instructions running on one or more computer systems), or any combination of hardware and software.

FIG. 5 illustrates a method 250. At 252, the method detects an error in data. The data could be data that is transferred between a data bus and at least one device that is coupled to the data bus, and the error could comprise at least one corrupted bit in the data. At 254, the method records error information in a data bus register. The recording the error information could be in response to detecting the error. The error information can be sufficient to detect a quantity and a location of the at least one corrupted bit in the data, and the data bus register could be accessible by a device interface of the at least one device.

FIG. 6 illustrates an example method 300 for recording and retrieving error information associated with an error in a data bus register. At 302, the method determines if an error is detected in data. The error could be a single-bit or a multi-bit error that is detected in a corrupted data block that is being transferred to or from a device that is coupled to a data bus. The data bus, for example, can be a PCI bus operative to interconnect a number of devices for communication across the PCI bus. The device, for example, can be a memory device, a SCSI port, a bus interface, or any other type of I/O peripheral device. The error could occur as a result of a device malfunction during a typical operation of a computer, or the error could occur as a result of error injection, such as resulting from a software routine for testing ECC. If an error is detected (YES), the method proceeds to 304, at which the corrupted data block could optionally be corrected to produce a corrected data block. The detection and the correction of the corrupted data block could comprise an error system or ECC, and could occur in the same IC or in separate ICs, such as a chipset for the device that is implementing the method 300.

At 306, the method determines if error recordation is enabled. The error recordation enable could be a single-bit that, when set, enables the error information to be recorded into a data bus register. The error recordation could be enabled by an input from a user, or it could be enabled automatically at predetermined times by the operating system or other software routine, such as could be running in a computer system processor. If recordation is enabled (YES), the method proceeds to 308. At 308, error information associated with the error is recorded into the data bus register. The error information could be any information that is sufficient to determine the location and the quantity of corrupted bits in a corrupted data block. As one example, the error information can include the corrupted data block, the corrected data block or both the corrupted data block and the corrected data block. If the data bus register is specific to a given device, the address locations within the data bus register where the error information is recorded can be predetermined by the manufacturer of the device.

At 310, error information is retrieved from the data bus register. For example, the error information can be retrieved by accessing the data bus register through the data bus. Access to the data bus register through the data bus could occur from another device that is connected to the data bus, or could occur by connecting a diagnostic tool to the data bus through an associated (e.g., external) interface to the data bus, such as a serial port or a parallel port. Access to the data bus register through the data bus could occur outside of the operating system of a computer that includes the data bus, such that the data bus register can be accessed despite a computer crash that renders the operating system inoperative. Additionally, since the access can be directly through the data bus, the retrieval and access to the error information can be operating system independent. The location and size of the register space to which the error information was recorded can be predetermined by the manufacturer of the device that is configured to store the error information in the register.

At 312, the retrieved error information is analyzed. The analysis of the retrieved data could include comparing the error information with the expected data block to determine the cause of the error. As mentioned above, the error information can include a corrupted data block, a corrected data block or both. A source of the error could thus be determined by comparing the corrupted data block with the corrected data block. Additionally or alternatively, if the error was caused by injection of a known error, the error information could be used to determine if the error detection and/or error correction circuitry is performing correctly, such as described herein.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A system comprising:
a data bus register, coupled to the data bus, that is associated with a data bus and with at least one device; and
an error record component that causes error information to be recorded in the data bus register in response to detecting an error in data that is being transferred through a data path located between the data bus and the at least one device, the error information being sufficient to determine a quantity and a location of the error in the data that is being transferred through the data path.

2. The system of claim 1, further comprising an error detect component that monitors data transferred through the data path and that detects the error in the data that is being transferred through the data path.

3. The system of claim 2, wherein the error information comprises a corrupted data block that includes the error in the data that is being transferred through the data path.

4. The system of claim 2, wherein the error detect component further comprises error correction circuitry configured to correct one of a single-bit error and a multi-bit error detected in the data that is being transferred through the data path to produce a corrected data block.

5. The system of claim 4, wherein the error information comprises the corrupted data block and the corrected data block.

6. The system of claim 2, wherein the at least one device comprises a device interface connected between the data bus and the at least one device, the device interface comprising the error detect component, the data path, and the error record component.

7. The system of claim 6, wherein the device interface further comprises the data bus register, the error information being stored at a predetermined location in the data bus register.

8. The system of claim 7, wherein the data bus comprises a peripheral component interconnect (PCI) bus, and the data bus register comprises a configuration space PCI register of the device interface.

9. The system of claim 1, further comprising:
an external interface connected with the data bus; and
a tool coupled to the external interface to at least one (i) inject at least one simulated error into the system to create the error in the data that is being transferred through the data path and (ii) retrieve the error information from the data bus register.

10. The system of claim 1, wherein the at least one device comprises at least one of a memory device, a second bus structure, and a peripheral device that is accessible via the data bus to cause the data to be transferred through the data path.

11. The system of claim 1, further comprising an enable feature to selectively enable and disable the error information to be recorded in the data bus register.

12. A system comprising:
a data bus;
a data bus register operatively associated with the data bus; and
a device interface coupled to the data bus and capable of accessing the data bus register, the device interface configured to transfer data between at least one device and the data bus, the device interface comprising:
an error detector that detects an error in the data that is transferred between the at least one device and the data bus, the error in the data comprising at least one corrupted bit in the data, and
an error record component that causes error information to be recorded in the data bus register in response to the error detector detecting the error in the data, the error information being sufficient to determine a quantity and a location of the at least one corrupted bit in the data.

13. The system of claim 12, further comprising an enable feature operative to selectively enable and disable the error record component to store the error information in the data bus register.

14. The system of claim 13, wherein the enable feature comprises a register value that is set by at least one of a user input via the data bus and by a software routine.

15. The system of claim 12, further comprising an external interface connected with the data bus, the external interface providing access to at least the error information in the data bus register.

16. The system of claim 12, wherein the data bus comprises a peripheral component interconnect (PCI) bus, and the data bus register comprises a configuration space PCI register of the device interface.

17. The system of claim 12, further comprising a diagnostic tool operative to inject simulated errors into valid data to create the error in the data.

18. The system of claim 12, wherein the device interface further comprises error correction circuitry configured to correct the error in the data and to produce a corrected block of the data, the error information further comprising the corrected block of the data and a corrupted block of data that includes the at least one corrupted bit in the data.

19. A system on a computer comprising:
means for detecting an error in data that is transferred between a data bus and at least one device coupled to the data bus via a device interface, the error comprising at least one corrupted bit in the data;
means for storing error information at a predetermined location, the means for storing being associated with the at least one device and accessible via the data bus, the error information being sufficient to detect a quantity and a location of the at least one corrupted bit in the data;
means for causing the error information to be recorded in the means for storing in response to the error in the data being detected by the means for detecting.

20. The system of claim 19, wherein the data bus comprises a peripheral component interconnect (PCI) bus, and the means for storing comprises a configuration space PCI register that is part of the device interface.

21. The system of claim 19, further comprising means for selectively enabling the means for causing the error information to be recorded to record the error information in the means for storing.

22. The system of claim 19, further comprising means for correcting the error to produce corrected data, the error information further comprising the corrected data.

23. The system of claim 19, further comprising means for externally accessing the means for storing to obtain the error information.

24. The system of claim 19, further comprising means for simulating errors in valid data; and
means for accessing the error information from the means for storing, the simulated errors being compared relative to the error information to determine if the device interface of the at least one device is operating within expected operating parameters.

25. A method comprising:
detecting an error in data that is transferred between a data bus and at least one device that is communicatively coupled with the data bus, the error comprising at least one corrupted bit in the data; and
recording error information in a data bus register in response to detecting the error in the data, the error information being sufficient to detect a quantity and a location of the at least one corrupted bit in the data, and the data bus register being accessible via the data bus.

26. The method of claim 25, further comprising selectively enabling and disabling the error information to be recorded in the data bus register.

27. The method of claim 25, further comprising correcting the least one corrupted bit in the data to produce a corrected block of the data, the corrected block of the data being recorded in the data bus register as part of the error information.

28. The method of claim 25, further comprising accessing the error information in the data bus register via an external interface connected with the data bus.

29. The method of claim 25, wherein the data bus comprises a peripheral component interconnect (PCI) bus, and the data bus register comprises a configuration space PCI register associated with the at least one device, the error information being stored in a predetermined location of the configuration space PCI register in response to detecting the error.

30. The method of claim 25, further comprising injecting simulated errors into valid data and comparing the simulated error relative to the error information to determine if a computer system implementing the method is operating within expected operating parameters.
